(19) United States
(12) Patent Application Publication
(10) Pub. No.: US 2012/0313037 A1
(43) Pub. Date: Dec. 13, 2012

(54) CHLORIDE-CONTAINING SILICON

(75) Inventors: Norbert Auner, Glashuetten (DE); Christian Bauch, Muldenstein (DE); Sven Holl, Gueckingen (DE); Rumen Deltschew, Leipzig (DE); Javad Mohsseni, Bitterfeld-Wolfen (DE); Gerd Lippold, Leipzig (DE)

(73) Assignee: SPAWNT PRIVATE S.A.R.L., Luxembourg (LU)

(21) Appl. No.: 13/512,461

(22) PCT Filed: Dec. 2, 2010
(86) PCT No.: PCT/EP2010/068730

§ 371 Date: Aug. 27, 2012

(30) Foreign Application Priority Data
Dec. 2, 2009 (DE) 10 2009 056 436.5

(51) Int. Cl. C01B 33/107; C09K 3/00

(52) U.S. Cl. 252/182.32; 423/342

(57) ABSTRACT

A chlorinated polysilane has the formula SiClx wherein x=0.01−0.8 and which can be produced by thermolysis of a chloropolysilane at a temperature below 600° C.

### RELATED APPLICATIONS

This is a §371 of International Application No. PCT/EP2010/068730, with an international filing date of Dec. 2, 2010 (WO 2011/067332, published Jun. 9, 2011), which is based on German Patent Application No. 10 2009 056 436.5, filed Dec. 2, 2009, the subject matter of which is incorporated by reference.

### TECHNICAL FIELD

This disclosure relates to polysilanes, particularly chloride-containing silicon, and methods of producing such polysilanes.

### BACKGROUND

Chloride-containing silicon is known in various forms. For example, WO 2006/125425 A1 discloses a process for producing silicon from halosilane wherein, in a first step, the halosilane is converted under a plasma discharge into a halogenated polysilane which is subsequently, in a second step, decomposed to silicon by heating. It is preferably heated to a temperature of 400° C.-1500° C. to decompose the halogenated polysilane. The examples utilize temperatures of 800° C., 700° C., 900° C. and again 800° C. As far as the employed pressure is concerned, the preference is for using reduced pressure in that the examples are carried out in vacuo. That process aims to produce silicon as pure as possible. In particular, the silicon obtained has a low halide content.

Particular variants of chloride-containing silicon are chlorinated polysilanes (PCS). It could be helpful, however, to provide further variants of such chlorinated polysilanes.

### SUMMARY

We provide an amorphous chlorinated polysilane of the formula SiClₓ wherein x−0.01 to 0.8.

We also provide a process for producing the polysilane, including: A) providing a chloropolysilane produced thermally or plasma-chemically, and B) thermolyzing the chloropolysilane at a temperature below 600° C.

### BRIEF DESCRIPTION OF THE DRAWINGS

FIG. 1 is an illustration of an IR spectra of a chloride-containing silicon of the composition SiCl_{0.05} to SiCl_{0.07}.

FIG. 2 shows an IR spectra of a chloride-containing silicon of the composition SiCl_{0.7}.

FIG. 3 shows a ²⁹Si solid state NMR spectra of a chloride-containing silicon having the empirical formula SiCl_{0.7}.

FIG. 4 shows a portion of a detailed ²⁹Si solid state NMR spectra taken from FIG. 3.

FIG. 5 shows a ¹H solid state NMR spectra of a chloride-containing silicon having the empirical formula SiCl_{0.7}.

FIG. 6 shows a Raman spectrum of a chloride-containing silicon having the empirical formula SiCl_{0.05}.

FIG. 7 shows an X-ray powder diffractogram (Cu—K_{α}) of a chlorinated polysilane obtained at high temperature.

### DETAILED DESCRIPTION

We provide a chlorinated polysilane having the empirical formula SiClₓ wherein x=0.01 to 0.8, which may be amorphous in particular.

The chlorinated polysilane of the (empirical) formula SiClₓ wherein x=0.01 to 0.8 (determined analytically) is a highly crosslinked chlorinated polysilane since x is <1. Hence, the compound has a spatial silicon scaffold which, in addition to silicon centers with one or more chlorine substituents, must likewise possess silicon centers having no chlorine substituents, only bonds leading to further silicon centers or atoms. In contrast, chlorinated polysilanes of the empirical or analytical formula SiClₓ wherein 1<x<2 are compounds which only have a relatively slight degree of crosslinking since on average each silicon atom has at least one chlorine substituent. These polysilanes can be characterized, for example, by a polycyclic or a sheetlike, two-dimensional structure which, compared with compounds having a chain and/or ring structure and x≧2, additionally have crosslinking points.

Compared with non-amorphous chlorinated polysilane, our amorphous chlorinated polysilane typically has an enhanced degree of reactivity which, in particular, is believed to be attributed to the energetically higher state and the less compact structure. This increased reactivity can be taken advantage of, for example, by using the amorphous chlorinated polysilanes to remove impurities from metallurgical silicon.

It is preferable that x=0.5 to 0.7. A chlorinated polysilane of this type has a reactivity which makes it particularly suitable for further use. The chloride content here and herein is determined by completely digesting the sample and then titrating the chloride by the Mohr method.

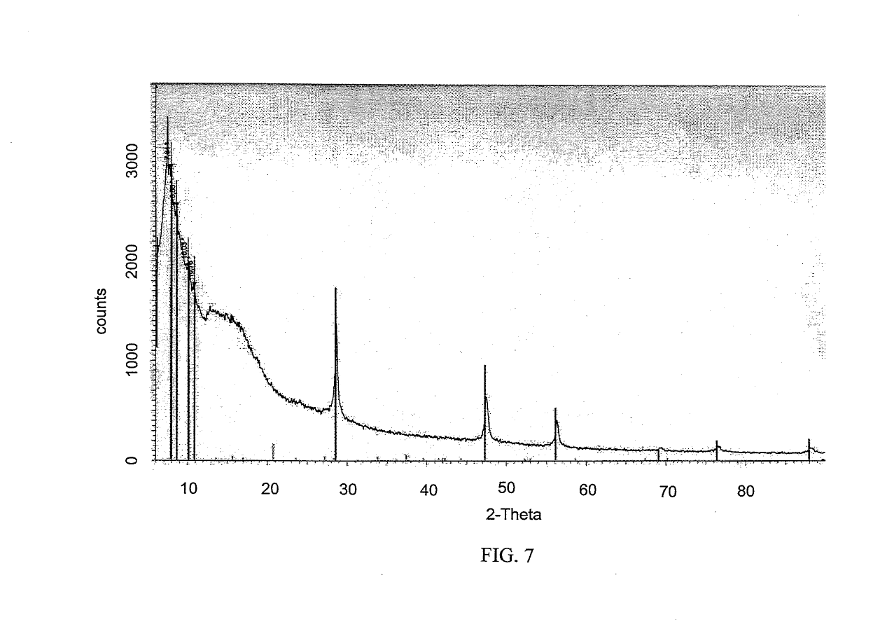

The chlorinated polysilane has a high degree of crosslinking It can therefore more particularly be an amorphous substance, in particular when production takes place below 600° C. and does not exceed a few hours in duration. The fact that the consistency is amorphous was determined by X-ray powder diffractometry. An amorphous state is present when there are no signals (or no diffraction intensities) in the diffractogram. When production takes place at higher temperatures, for example, at 900° C., this results in an increasingly crystalline product which, in the X-ray powder diffractogram, shows the intensities of silicon as shown in FIG. 7. In general, the chlorinated polysilane will, in the normal case, not show any signals attributable to crystalline silicon, i.e., more particularly no signals at 2 theta values of 7.84, 8.55, 10.03, 10.76, 28.6, 47.5, 56.3, 69.4, 76.6 and 88.2 (±0.2). These values are based on a powder diffractogram recorded using Cu—Kα radiation.

The chlorinated polysilane can also be referred to as “chloride-containing silicon.”

The chlorinated polysilane can also be hydrogen-containing The hydrogen can be more particularly present therein attached to Si. In the normal case, the hydrogen content of the polysilane is less than 5 atomic %, in particular less than 2 atomic %, for example, less than 1 atomic %.

Such amounts of hydrogen can have an advantageous effect in the further use of the chlorinated polysilane, for instance in the synthesis of perchlorinated disilane by chlorination, in relation to the yield of the reaction.

The chlorinated polysilanes may have an orange-red or a dark red or brown or gray color. An orange-red to brown color is indicative of a heightened level of chlorine and, hence, is generally preferable.

The chlorinated polysilane may exhibit the following behavior with regard to dissolution: when the polysilane is suspended in 10 times the weight of an inert solvent, less than 20% of the mass used is soluble. Less than 20% of the mass is oftentimes soluble even on suspension in 100 times the weight of a (any) inert solvent. An inert solvent here is a solvent which does not react with chlorinated silanes, and more particularly is a non-nucleophilic aprotic solvent. The above remarks apply more particularly to the dissolution behavior in at least one, but more particularly all of the following solvents: benzene, toluene and cyclohexane.

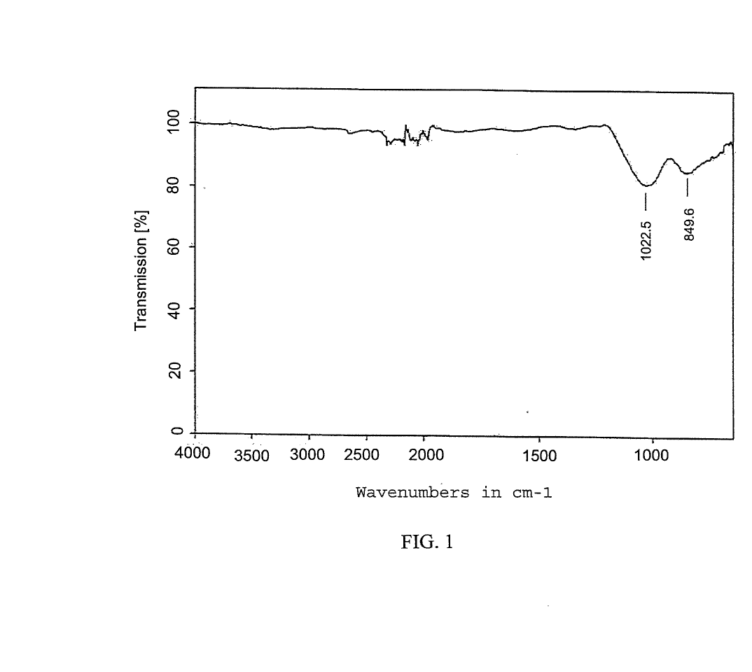

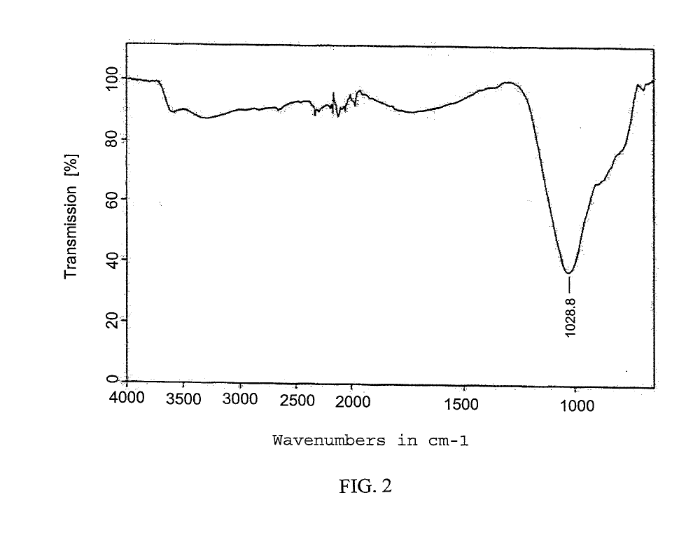

The highly crosslinked chlorinated polysilane will be more particularly elucidated with reference to the compounds SiCl_{0.05} to SiCl_{0.07} and SiCl_{0.7} in the following. IR-spectroscopic measurements (ATR technique, diamond single reflection) on such chloride-containing silicon show inter alia a band in the range from 1019 to 1039 wavenumbers, more particularly at 1029 cm⁻¹. The intensity is dependent on the chloride content and increases with increasing chloride content, as is apparent from comparing FIGS. 1 and 2. Further significant bands occur in the range from 840 to 860 and/or in the range from 2300 to 2000 wavenumbers. Bands in the range from 2300 to 2000 wavenumbers occur more particularly when the chlorinated polysilane contains hydrogen and can more particularly be attributed to Si—H vibrations. “Significant” bands are to be understood as meaning that the intensity of a band is greater than 10% of the band having the highest intensity.

NMR-spectroscopic analyses show the following results for the product obtained from plasma-chemically produced chlorinated polysilane:
(i) ²⁹Si NMR (solid state): δ ppm; 3.53; −0.37, −4.08, −6.47, −7.82, −18.67, −45.81, −79.91 (sharp); 40 to −21 and −60 to −118 (broad). “Sharp” is generally to be understood as meaning that the full width at half maximum value of the signal in question does not exceed 100 hertz. “Broad” signals are generally to be understood as meaning that there are full width at half maximum values of above 100 hertz in the solid-state NMR.
(ii) ¹H NMR (solid state): The product shows in the ¹H NMR spectrum a broad, weak signal at 3 to 10 ppm, in particular at 5 to 10 ppm, more particularly a signal having a maximum in the chemical shift range between 8 and 6 ppm. This is caused by the residual hydrogen content of the product in that the signal shape is typical of the product. Furthermore, according to expectations, the signal intensity is low, since levels of hydrogen were also low in the starting substance. The chemical shift in the range from 3 to 10 ppm encompasses the expected shift range for the product. Therefore, the observed ¹H NMR spectrum is characteristic for the product obtained via our processes from plasma-chemically produced chlorinated polysilane. The hydrogen content is determined by integration of ¹H NMR spectra using an internal standard and comparing the resulting integrals at known mixing ratio.

The starting material used can in particular be chlorinated polysilane of the empirical formula SiClₓ where x=0.2-0.8, which is obtained by thermolysis of chloropolysilane, for example, (SiCl₂)ₓ, which was produced via a plasma-chemical process or thermally.

Plasma-chemically produced chloropolysilane, for example, (SiCl₂)ₓ, can in particular be a halogenated polysilane as a pure compound or as a mixture of compounds each having at least one direct Si—Si linkage, wherein the substituents consist of halogen or of halogen and hydrogen and wherein the atomic ratio for substituent:silicon is at least 1:1 in the composition, wherein
a. the hydrogen content of the polysilane is less than 2 atomic %,
b. the polysilane contains almost no branched chains and rings in that the level of branching points of the short-chain fraction, in particular of the summed fraction of perhalogenated derivatives of neohexasilane, neopentasilane, isotetrasilane, isopentasilane and isohexasilane is below 1%, based on the entire product mixture,
c. it has a Raman molecular vibration spectrum of I₁₀₀/I₁₃₂ above 1, where I₁₀₀ is the Raman intensity at 100 cm⁻¹ and I₁₃₂ is the Raman intensity at 132 cm⁻¹,
d. its significant product signals in ²⁹Si NMR spectra are in the chemical shift range from +15 ppm to −7 ppm when the substituents are chlorine.

The level of branching points herein is determined by integrating the ²⁹Si NMR signals for the tertiary and quaternary silicon atoms. The “short-chain fraction” of halogenated polysilanes is to be understood as referring to any silane having up to 6 silicon atoms. Alternatively, the fraction of chlorinated short-chain silanes is particularly quick to determine using the following procedure: first the range from +23 ppm to −13 ppm in the ²⁹Si-NMR is integrated (signals from primary and secondary silicon atoms appear therein in particular in the range) and subsequently the signals for tertiary and quaternary silicon atoms are integrated in the range from −18 ppm to −33 ppm and from −73 ppm to −93 ppm of the respective perchlorinated derivatives of the following compounds: neohexasilane, neopentasilane, isotetrasilane, isopentasilane and isohexasilane. Thereafter, the ratio of the respective integrations I_{short-chain}:I_{primary/secondary} is determined. This is in respect of the summed integration for the respective perchlorinated derivatives of neohexasilane, neopentasilane, isotetrasilane, isopentasilane and isohexasilane less than 1:100.

In addition, the synthesis and characterization of these long-chain halogenated polysilanes is described in WO 2009/143823 A2, the subject matter of which is incorporated herein by reference.

It is further possible to use perhalogenated polysilanes as described in WO 2006/125425 A1, the subject matter of which is likewise incorporated herein by reference, although it must be noted that the plasma used therein has a higher power density, leading to a changed spectrum of products.

Thermally produced chloropolysilane, for example, (SiCl₂)ₓ, can in particular be a chlorinated polysilane as a pure compound or a mixture of compounds which each have at least one direct Si—Si linkage and the substituents of which consist of chlorine or of chlorine and hydrogen and in the composition of which the atomic ratio of substituent:silicon is at least 1:1, wherein
a. the polysilane consists of rings and chains having a high proportion of branching points which is >1% based on the entire product mixture,
b. it has a Raman molecular vibration spectrum of I₁₀₀/I₁₃₂ below 1, where I₁₀₀ is the Raman intensity at 100 cm⁻¹ and I₁₃₂ is the Raman intensity at 132 cm⁻¹,
c. its significant product signals in ²⁹5i NMR spectra are in the chemical shift range from +23 ppm to −13 ppm, from −18 ppm to −33 ppm and from −73 ppm to −93 ppm.

The synthesis and characterization of these branched halogenated polysilanes is described in WO 2009/143824 A2, the subject matter of which is incorporated herein by reference.

Our chlorinated polysilane is obtainable by thermolytic decomposition of chlorinated polysilane, in particular in a temperature range of 350° C.-1200° C. To obtain an amorphous chlorinated polysilane, the temperature will generally be less than 600° C. It can be between 400 and 500° C., for example. However, amorphous chlorinated polysilane is also obtainable at higher temperatures provided that the reaction time is made sufficiently short.

The thermolytic decomposition can take place at any desired pressure. However, reduced pressure in comparison to atmospheric pressure, for example, a pressure <300 hPa, can be advantageous since short-chain chlorosilanes formed in the thermolysis are automatically distilled off. Yet typically the pressure will be more than 100 hPa not to push the distillative removal excessively. Even lower pressures can be sensible for reactions at low temperatures and such that higher chlorine contents may be achieved. When atmospheric pressure is employed, the short-chain chlorosilanes can also be distilled off or removed by extraction with SiCl₄ later on.

### EXAMPLE 1

In a continuous thermolysis, the temperature was adjusted to 450° C. in a suitable reaction vessel, and the reaction vessel was evacuated down to 250 hPa. A polychlorosilane mixture having an average empirical formula SiₙCl₂ₙ(Øn=18) was added dropwise, in the form of an 80% solution in SiCl₄, as low molecular weight diluent, upstream of the thermolysis zone at a local temperature of 120° C. The polychlorosilane mixture was advanced through the hot zone of the apparatus (450° C.). The residence time in the hot zone here is in particular between 30 minutes and one hour. In the process, the polychlorosilane mixture converted into a solid, highly crosslinked chlorinated polysilane (chloride-containing silicon) of the empirical formula SiCl_{0.7}, having an orange to red color, and short-chain chlorosilanes. The SiCl_{0.7} was collected in a collecting vessel. The diluent SiCl₄ and short-chain chlorosilanes produced by the thermolysis (SiCl₄, Si₂Cl₆, Si₃Cl₈) were drawn off as vapor and condensed.
Yields based on the starting material: 20% by mass of SiCl_{0.7} and 80% by mass of short-chain chlorosilanes (diluent quantity not included).

### EXAMPLE 2

A 50-60% solution of a polychlorosilane mixture having an average empirical formula of SiₙCl₂ₙ (Øn=18) in SiCl₄ is charged to a quartz glass container and heated for 2 to 3 h to 300° C. at a pressure of 300 to 500 mbar. Thereafter, the pressure is reduced in stages to finally 10⁻¹ to 10⁻² mbar and heating to 900° C. is effected in the course of 3 h. Lastly, the temperature of 900° C. is maintained for 1 h. The vapors which formed during the thermal decomposition of the polychlorosilane mixture are condensed out in a cold trap cooled with liquid nitrogen. The polychlorosilane mixture converted into a solid, highly crosslinked chlorinated polysilane (chloride-containing silicon) of the empirical formula SiCl_{0.05} to SiCl_{0.07}, having a gray color, and short-chain chlorosilanes. After termination of the reaction, the container was allowed to cool down and the solid product removed under inert gas.
Yields based on the starting material: 10-15% by mass of SiCl_{0.05} to SiCl_{0.07} and 85-90% by mass of short-chain chlorosilanes (diluent quantity not included).

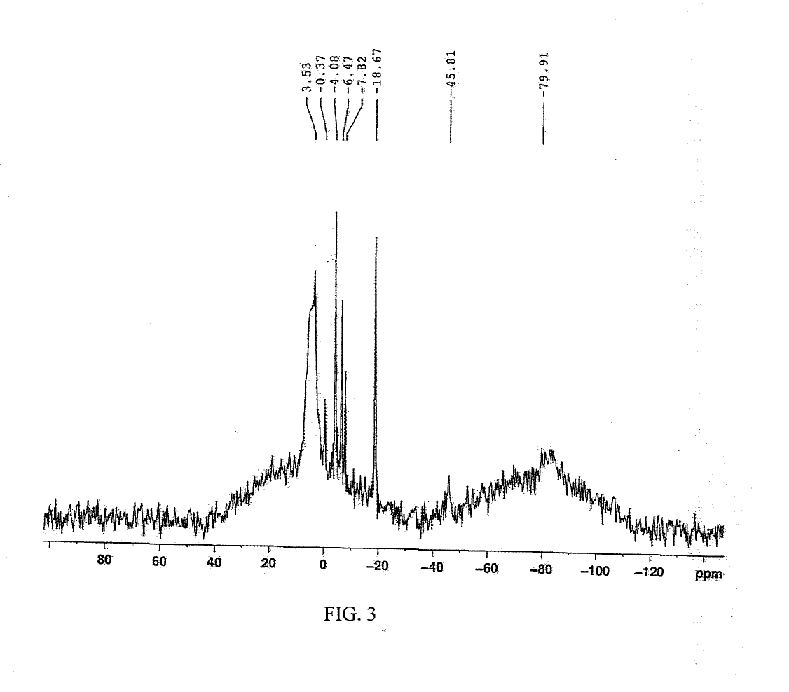

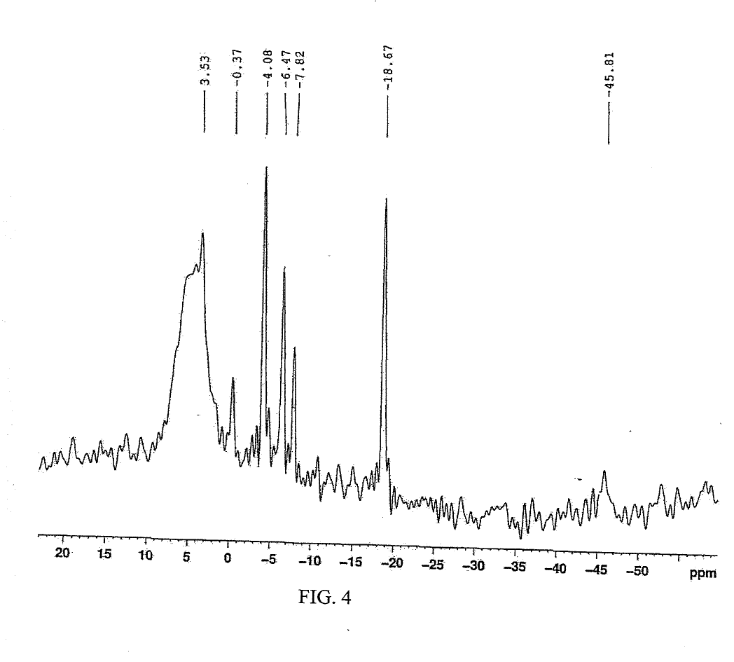

FIGS. 1 and 2 below show IR spectra of a chloride-containing silicon of the composition SiCl_{0.05} to SiCl_{0.07} (FIG. 1) and of SiCl_{0.7} (FIG. 2). The IR spectra were recorded on the solid material with a Bruker Optics IFS48 spectrometer with ATR measurement unit (“Golden Gate,” diamond window, single reflection). FIGS. 3 and 4 show ²⁹Si solid state NMR spectra of a chloride-containing silicon having the empirical formula SiCl_{0.7}, with FIG. 4 showing a detail from FIG. 3.

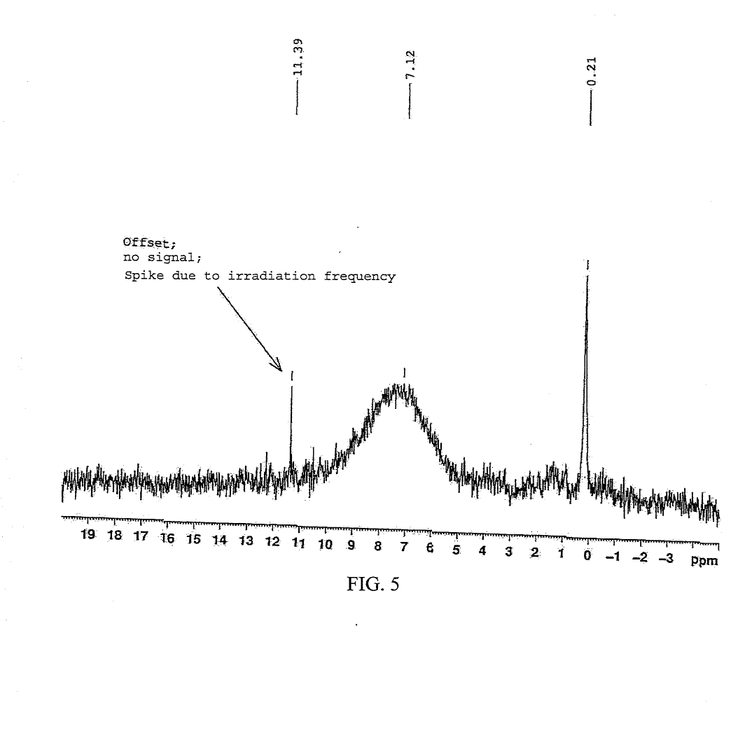

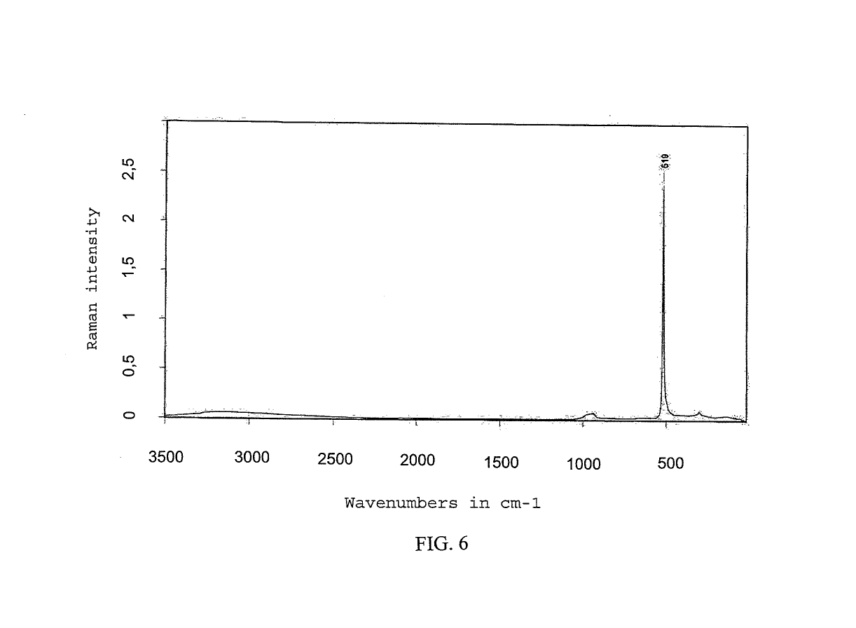

FIG. 5 shows the ¹H solid state NMR spectrum of the chloride-containing silicon having the empirical formula SiCl_{0.7}. The solid state NMR spectra were recorded with a Bruker DSX-400 NMR spectrometer, the measurement conditions being on the one hand ²⁹Si HPDec, 79.5 MHz, rotational frequency: 7000 Hz, externally referenced to TMS=0 ppm, and on the other for ¹H with the pulsed program zg4pm.98 at 400 MHz, rotational frequency: 31115 Hz with 2.5 mm MAS head, referenced to TMS=0 ppm, the measurements being carried out at room temperature with the undiluted samples unless an internal standard was added for the integration. FIG. 6 shows a Raman spectrum of the chloride-containing silicon having the empirical formula SiCl_{0.05}. FIG. 7 shows an X-ray powder diffractogram (Cu—Kα) of a chlorinated polysilane obtained at high temperature, where the signals of crystalline fractions are attributable to silicon.

1. An amorphous chlorinated polysilane of the formula SiClₓ wherein x=0.01 to 0.8.

2. The polysilane according to claim 1, wherein x is 0.5 to 0.7.

3. The polysilane according to claim 1, having an ²⁹Si NMR spectrum with a broad signal in a chemical shift range of 0 to 10 ppm with a full width at half maximum value above 100 Hz and a further broad signal in a chemical shift range of −60 to −100 ppm with a full width at half maximum value above 100 Hz.

4. The polysilane according to claim 1, having an ²⁹Si NMR spectra have with sharp signals in a chemical shift range of 10 ppm to −20 ppm, wherein the signals occur in following chemical shift ranges: at least one signal of −18 to −20 ppm and/or at least four signals of 8 to −10 ppm and/or at least one signal of −75 to −85 ppm.

5. The polysilane according to claim 4, wherein ²⁹Si NMR spectra have at least one sharp signal in each of following chemical shift ranges: −7 to 2 ppm, −1 to −1 ppm, −3 to −5 ppm, −5.5 to −7.5 ppm, −7.5 to −9 ppm and −18 to −20 ppm.

6. The polysilane according to claim 1, further comprising hydrogen attached to Si.

7. The polysilane according to claim 6, wherein hydrogen content of the polysilane is less than 5 atomic %.

8. The polysilane according to claim 1, having an ¹H NMR spectra with a broad signal in a chemical shift range of 10 to 5 ppm with a full width at half maximum value above 100 Hz.

9. The polysilane according to claim 1, having an IR spectrum with at least one band of 840 to 860 and/or 1019 to 1039 and/or 2300 to 2000 wavenumbers.

10. The polysilane according to claim 9, wherein the IR spectrum has a band of 840 to 860, a band of 1019 to 1039 and a band of 2300 to 2000 wavenumbers.

11. The polysilane according to claim 1, having a Raman spectrum with at least one band of 280 to 330 and/or 510 to 530 and/or 910 to 1000 and/or a band of 2300 to 2000 wavenumbers.

12. The polysilane according to claim 1, having an orange-red or a dark red or brown or gray color.

13. The polysilane according to claim 1, wherein, when the polysilane is suspended in 10 times the weight of an inert solvent, less than 20% of the mass used is soluble.

14. The polysilane according to claim 1, obtained by thermolytic decomposition of chlorinated polysilane.

15. The polysilane according to claim 1, it is obtained from thermally produced chlorinated polysilane.

16. The polysilane according to claim 1, obtained from plasma-chemically produced chlorinated polysilane.

17. A process for producing the polysilane according to claim 1, comprising:
A) providing a chloropolysilane produced thermally or plasma-chemically, and
B) thermolyzing the chloropolysilane at a temperature below 600° C.

18. The polysilane according to claim 2, having an ²⁹Si NMR spectrum with a broad signal in a chemical shift range of 0 to 10 ppm with a full width at half maximum value above 100 Hz and a further broad signal in a chemical shift range of −60 to −100 ppm with a full width at half maximum value above 100 Hz.
